(19) United States
(12) Patent Application Publication
(10) Pub. No.: US 2008/0222237 A1
(43) Pub. Date: Sep. 11, 2008

(54) Web services mashup component wrappers

(75) Inventors: Adam D. Nathan, Kirkland, WA (US); John I. Montgomery, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/714,595

(22) Filed: Mar. 6, 2007

(51) Int. Cl. G06F 15/16

(52) U.S. Cl. 709/202

(57) ABSTRACT

Various technologies and techniques are disclosed for creating wrappers for use in visual mashup designers. The user selects a web service for which to create a wrapper that will allow the web service to be used as a component in a visual mashup designer. The system programmatically generates communication source code for the wrapper that knows how to send a request to the web service from the wrapper and how to interpret a response from the web service. The system also programmatically generates interaction source code for the wrapper that specifies how the wrapper should interact with the visual mashup designer. The wrapper can be used in the visual mashup designer for creation of web site mashups. The wrapper is operable to respond to visual mashup designer events.

### BACKGROUND

In modern web application development, it is possible to take output from one web application and combine it with another to create a completely new application. The result is called a “mashup”, since it is the result of the mashing together of two (or more) other web applications. To create a mashup, a developer must typically be highly sophisticated and knowledgeable in several areas, including JavaScript development, asynchronous programming practices, and extensible Markup Language (XML). Further, the developer must often devote a substantial amount of time discovering the features of any web applications that are to be part of the mashup.

### SUMMARY

Various technologies and techniques are disclosed for creating wrappers for use in visual mashup designers. The user selects a web service for which to create a wrapper that will allow the web service to be used as a component in a visual mashup designer. The system programmatically generates communication source code for the wrapper that knows how to send a request to the web service from the wrapper and how to interpret a response from the web service. The system also programmatically generates interaction source code for the wrapper that specifies how the wrapper should interact with the visual mashup designer. In one implementation, the communication source code and the interaction source code for the wrapper are generated in a dynamic language such as JavaScript. The wrapper can be used in the visual mashup designer for creation of web site mashups. The wrapper is operable to respond to visual mashup designer events.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagram illustrating components of a system for converting web site output for use in a visual mashup designer.

FIG. 2 is a diagrammatic view of a computer system of one implementation.

FIG. 3 is a diagrammatic view of a mashup component wrapper application of one implementation operating on the computer system of FIG. 2.

FIG. 4 is a high-level process flow diagram for one implementation of the system of FIG. 2.

FIG. 5 is a process flow diagram for one implementation of the system of FIG. 2 illustrating the stages involved in creating a wrapper for a web service and using the wrapper in a visual mashup designer.

FIG. 6 is a process flow diagram for one implementation of the system of FIG. 2 illustrating the stages involved in programmatically generating a wrapper for a web service.

FIG. 7 is a process flow diagram for one implementation of the system of FIG. 2 illustrating the stages involved in creating a web service from a wrapper web site so the web site can be used with a wrapper.

FIG. 8 is a simulated screen for one implementation that illustrates displaying a wrapper in a toolbox of a visual mashup designer.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope is thereby intended. Any alterations and further modifications in the described embodiments, and any further applications of the principles as described herein are contemplated as would normally occur to one skilled in the art.

The system may be described in the general context as an application that creates a web services mashup component wrapper, but the system also serves other purposes in addition to these. In one implementation, one or more of the techniques described herein can be implemented as features within an application development program such as MICROSOFT® VISUAL STUDIO®, or from any other type of program or service that allows for web application development. In another implementation, one or more of the techniques described herein are implemented as features with other applications that deal with creating web site mashups.

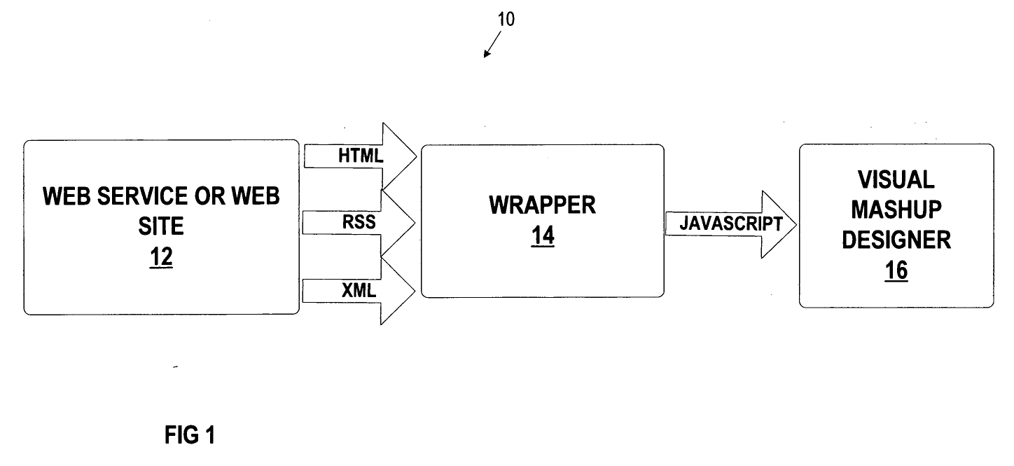

As shown in FIG. 1, in one implementation, the system provides a standard mechanism for converting the output of a web service and/or web site 12 into a wrapper 14 written in JavaScript or another dynamic language. The wrapper 14 can be used in a visual mashup designer 16. The wrapper 14 provides an interface on top of the web service 12 that abstracts the underlying application so that the developer can interact with the wrapper rather than the underlying application. The wrapper 14 can then be displayed in a toolbox or other area of the visual mashup designer 16 where the user can then create web sites mashups using a visual tool.

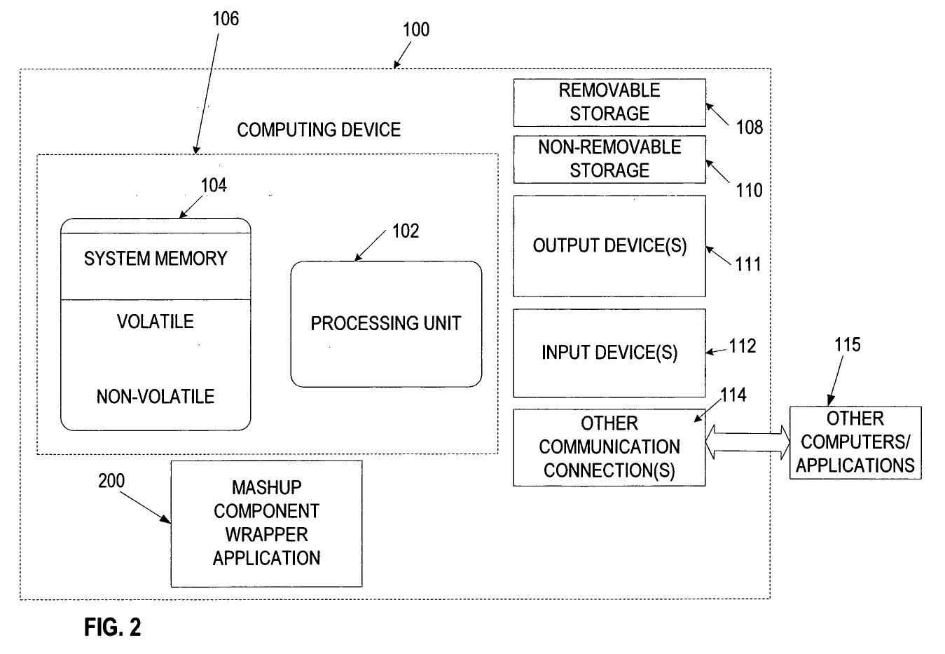

As shown in FIG. 2, an exemplary computer system to use for implementing one or more parts of the system includes a computing device, such as computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 2 by dashed line 106.

Additionally, device 100 may also have additional features/functionality. For example, device 100 may also include additional storage (removable and/or non-removable) including, but not limited to, magnetic or optical disks or tape. Such additional storage is illustrated in FIG. 2 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 100. Any such computer storage media may be part of device 100.

Computing device 100 includes one or more communication connections 114 that allow computing device 100 to communicate with other computers/applications 115. Device 100 may also have input device(s) 112 such as keyboard, mouse, pen, voice input device, touch input device, etc. Output device(s) 111 such as a display, speakers, printer, etc. may also be included. These devices are well known in the art and need not be discussed at length here. In one implementation, computing device 100 includes mashup component wrapper application 200. Mashup component wrapper application 200 will be described in further detail in FIG. 2.

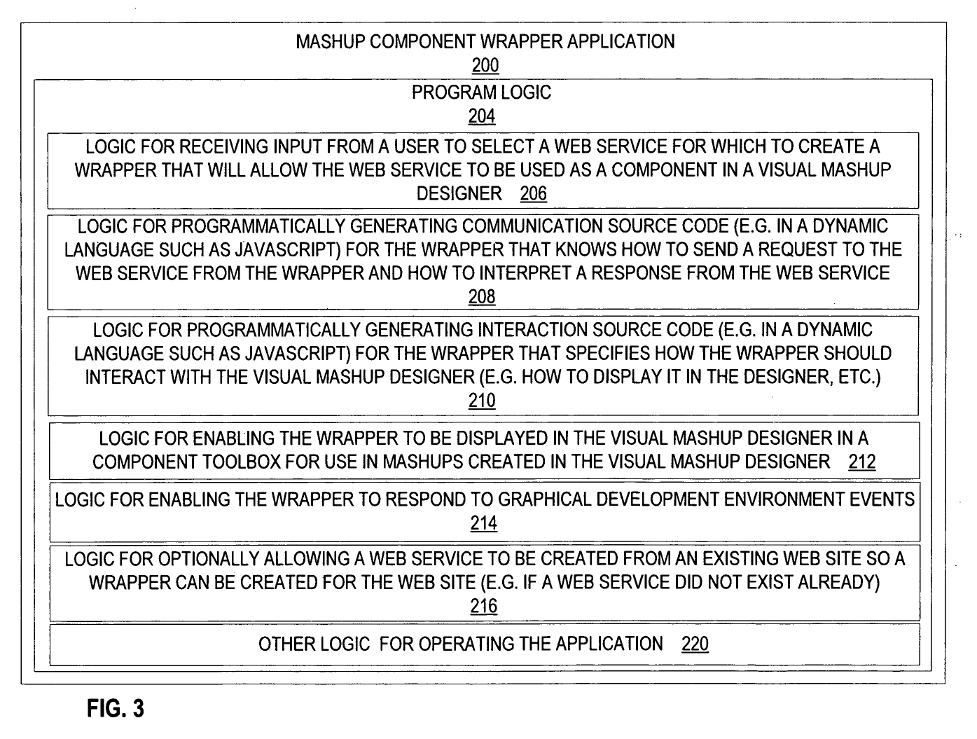

Turning now to FIG. 3 with continued reference to FIG. 2, a mashup component wrapper application 200 operating on computing device 100 is illustrated. Mashup component wrapper application 200 is one of the application programs that reside on computing device 100. However, it will be understood that mashup component wrapper application 200 can alternatively or additionally be embodied as computer-executable instructions on one or more computers and/or in different variations than shown on FIG. 2. Alternatively or additionally, one or more parts of mashup component wrapper application 200 can be part of system memory 104, on other computers and/or applications 115, or other such variations as would occur to one in the computer software art.

Mashup component wrapper application 200 includes program logic 204, which is responsible for carrying out some or all of the techniques described herein. Program logic 204 includes logic for receiving input from a user to select a web service for which to create a wrapper that will allow the web service to be used as a component in a visual mashup designer 206; logic for programmatically generating communication source code (e.g. in a dynamic language such as JavaScript) for the wrapper that knows how to send a request to the web service from the wrapper and how to interpret a response from the web service 208; logic for programmatically generating interaction source code (e.g. in a dynamic language such as JavaScript) for the wrapper that specifies how the wrapper should interact with the visual mashup designer (e.g. how to display it in the designer, etc.) 210; logic for enabling the wrapper to be displayed in the visual mashup designer in a component toolbox for use in mashups created in the visual mashup designer 212; logic for enabling the wrapper to respond to visual mashup designer events 214; logic for optionally allowing a web service to be created from an existing web site so a wrapper can be created for the web site (e.g. if a web service did not exist already) 216; and other logic for operating the application 220. In one implementation, program logic 204 is operable to be called programmatically from another program, such as using a single call to a procedure in program logic 204.

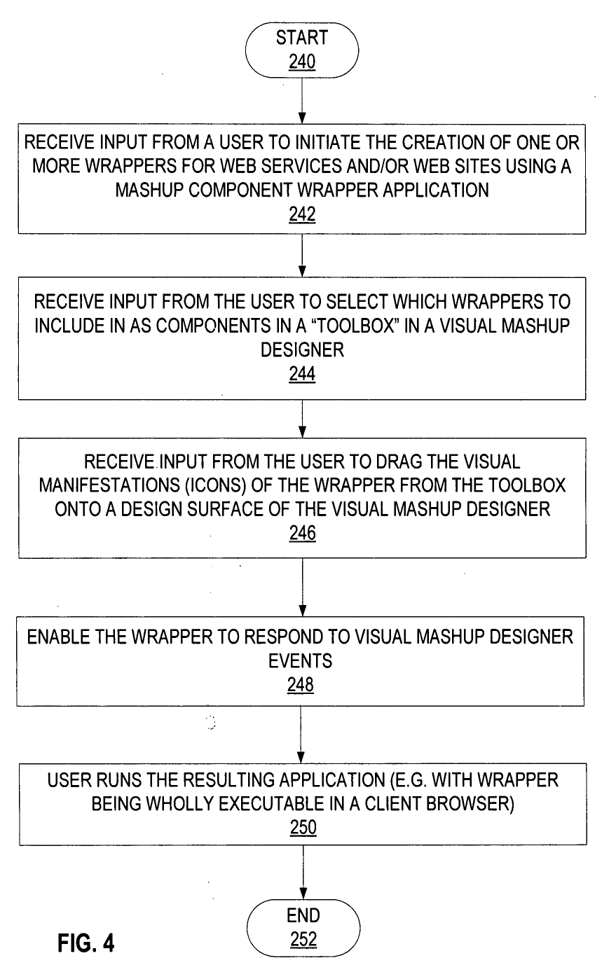

Turning now to FIGS. 4-7 with continued reference to FIGS. 1-2, the stages for implementing one or more implementations of mashup component wrapper application 200 are described in further detail. FIG. 4 is a high level process flow diagram for mashup component wrapper application 200. In one form, the process of FIG. 3 is at least partially implemented in the operating logic of computing device 100. The process begins at start point 240 with receiving input from the user to initiate the creation of one or more wrappers for web services and/or web sites using a mashup component wrapper application (stage 242). The system receives input from the user to select which wrappers to include in as components in a “toolbox” in a visual mashup designer (stage 244). The system receives input from the user to drag the visual manifestations (icons) of the wrapper from the toolbox onto a designer surface of the visual mashup designer (stage 246). The wrapper is operable to respond to visual mashup designer events (stage 248). The user runs the resulting mashup application (stage 250). The process ends at end point 252.

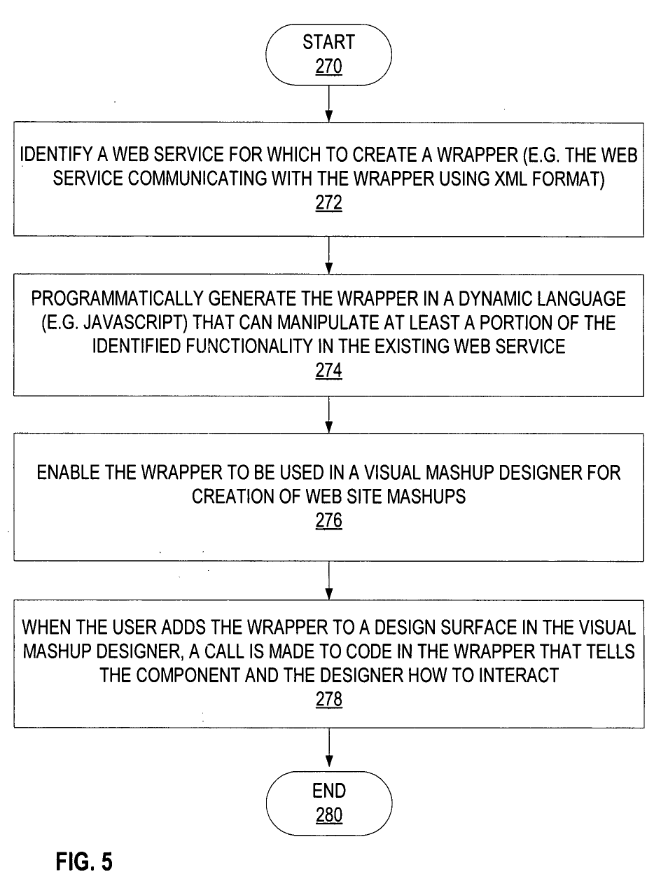

FIG. 5 illustrates one implementation of the stages involved in creating a wrapper for a web service and using the wrapper in a visual mashup designer. In one form, the process of FIG. 5 is at least partially implemented in the operating logic of computing device 100. The process begins at start point 270 with identifying a web service for which to create a wrapper (stage 272). In one implementation, the web service communicates with the wrapper using an XML format. A wrapper is programmatically generated in a dynamic language (e.g. JavaScript, etc.) that can manipulate at least a portion of the identified functionality in the existing web service (stage 274). The wrapper is operable to be used in a visual mashup designer for creating of web site mashups (stage 276). When the user adds the wrapper to a design surface in the visual mashup designer, a call is made to code in the wrapper that tells the component and the designer how to interact (stage 278). The process ends at end point 280.

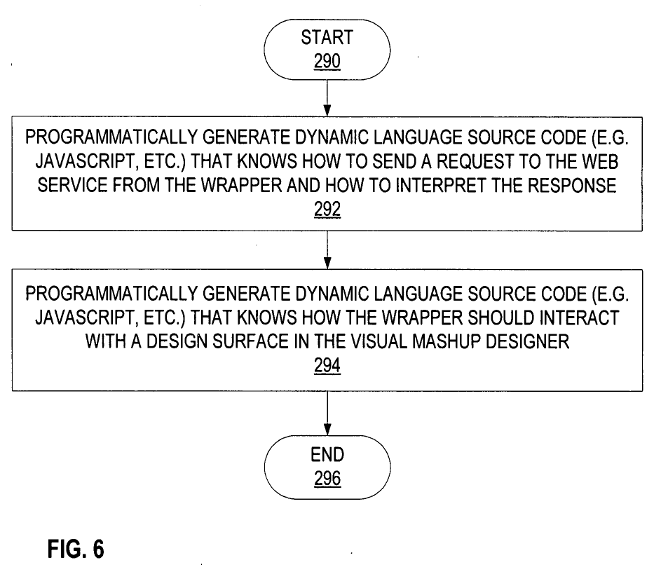

FIG. 6 illustrates one implementation of the stages involved in programmatically generating a wrapper for a web service. In one form, the process of FIG. 6 is at least partially implemented in the operating logic of computing device 100. The process begins at start point 290 with programmatically generating dynamic language source code (e.g. JavaScript, etc.) that knows how to send a request to the web service from the wrapper and how to interpret the response (stage 292). This process of generating the source code for communicating with the web service begins with determining the capabilities of the underlying service (e.g. the actions it can perform and the parameters that must be passed into those actions). These capabilities may be manifested through XML Web services standards such as WSDL (Web Services Description Language) and SOAP (Simple Object Access Protocol), or RSS (Really Simple Syndication), or JSON (JavaScript Object Notation), or POX (Plain Old XML), or any of a variety of other invocation systems. Once the capabilities are determined, an appropriate calling syntax is notated in the dynamic language (e.g. JavaScript) that will ultimately wrap the service, including potentially forming a proper URI (Uniform Resource Identifier) and notations that can appropriately parse and transform user input. During operation, upon invocation of the service through the wrapper, the wrapper must also understand how to parse the response, which typically will be returned by the underlying service in one form of XML. Parsing the response can involve regular expression matching and substantial transformation to render the result in a standardized system that can be interpreted either by humans or by another wrapper.

The system also programmatically generates dynamic language source code (e.g. JavaScript, etc.) that knows how the wrapper should interact with a design surface in the visual mashup designer (stage 294). In one implementation, this process involves two core aspects: ensuring the proper resources are in place to appear on the design surface and calling the proper methods to load the wrapper into the design surface. Proper resources include, but are not limited to, iconic representations of the wrapper, a properly-formatted list of potential input and output parameters, any documentation necessary to explain to an end-user how to use the wrapper, and any source code necessary to embed into the resulting application to properly call the wrapper from the resulting application. Loading the wrapper can be accomplished by having the proper resources at the right locations notated properly in the wrapper and then invoking a method on the designer that pulls those resources into the designer. The process ends at end point 296.

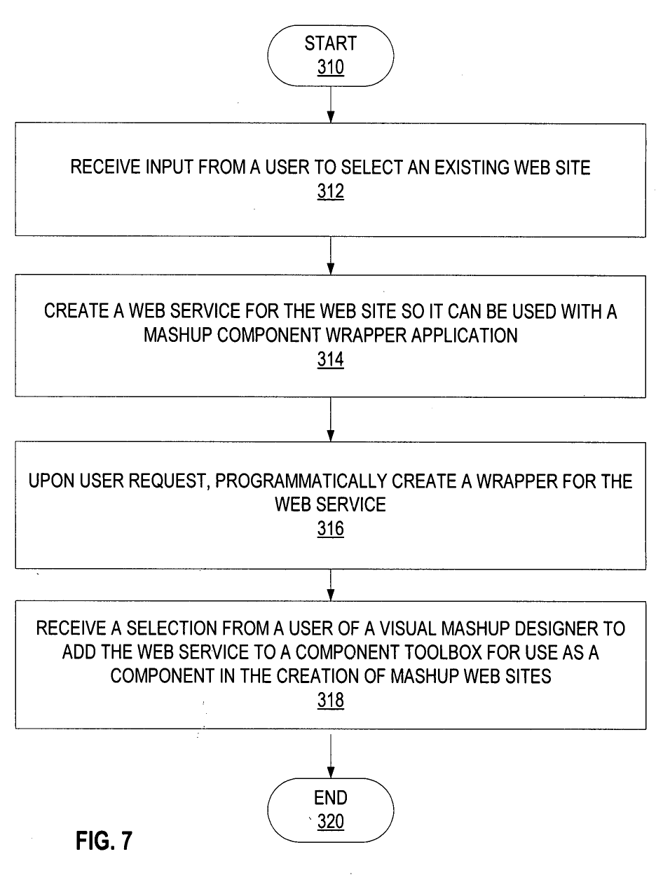

FIG. 7 illustrates one implementation of the stages involved in creating a web service from an existing web site so the web site can be used with a wrapper. In one form, the process of FIG. 7 is at least partially implemented in the operating logic of computing device 100. The process begins at start point 310 with receiving input from a user to select an existing web site (stage 312). A web service is created from the web site so it can be used with a mashup component wrapper application (stage 314). Upon user request, the system programmatically creates a wrapper for the web service (stage 316). A selection from a user of a visual mashup designer is received to add the web service to a component toolbox for use as a component in the creation of mashup web sites (stage 318). The process ends at end point 320.

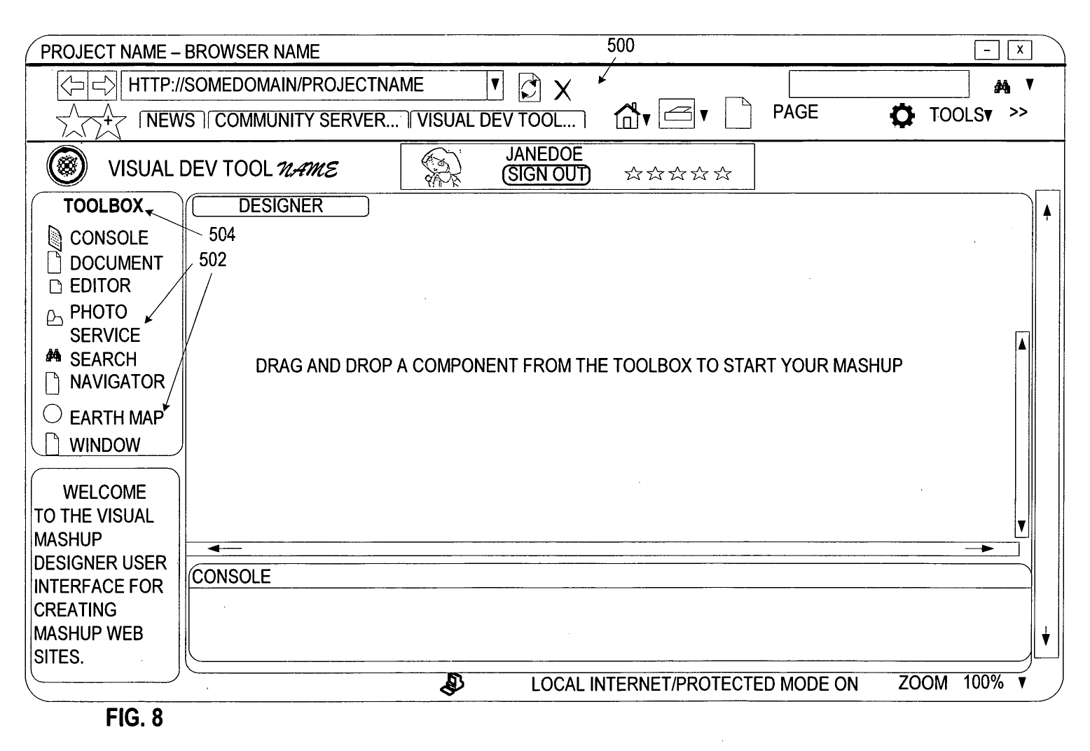

Turning now to FIG. 8, a simulated screen 500 is shown to illustrate a wrappers 502 being displayed components in a toolbox 504. Some or all of these wrappers can be created using some or all of the techniques described herein. The user can drop any of the components in the toolbox onto the design surface for use in creating web site mashups.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the client and/or server arrangements, user interface screen content, and/or data layouts as described in the examples discussed herein could be organized differently on one or more computers to include fewer or additional options or features than as portrayed in the examples.

What is claimed is:

1. A computer-readable medium having computer-executable instructions for causing a computer to perform steps comprising:
receive input from a user to select a web service for which to create a wrapper that will allow the web service to be used as a component in a visual mashup designer;
programmatically generate communication source code for the wrapper that knows how to send a request to the web service from the wrapper and how to interpret a response from the web service; and
programmatically generate interaction source code for the wrapper that specifies how the wrapper should interact with the visual mashup designer.

2. The computer-readable medium of claim 1, wherein the wrapper is operable to be executed wholly in a client browser.

3. The computer-readable medium of claim 1, wherein the communication source code and the interaction source code are generated using a dynamic language.

4. The computer-readable medium of claim 1, wherein the dynamic language is JavaScript.

5. The computer-readable medium of claim 1, wherein the wrapper is operable to respond to visual mashup designer events.

6. The computer-readable medium of claim 1, wherein the wrapper is operable to be displayed in the visual mashup designer in a component toolbox.

7. The computer-readable medium of claim 1, wherein the web service can be created from an existing web site.

8. A method for creating web service mashup wrapper components comprising the steps of:
identifying a web service for which to create a wrapper;
programmatically generating the wrapper in a dynamic language that can manipulate at least a portion of a functionality of the web service; and
enabling the wrapper to be used in a visual mashup designer for creation of web site mashups.

9. The method of claim 8, wherein the dynamic language is JavaScript.

10. The method of claim 8, wherein the web service is operable to communicate with the wrapper by transmitting data in an XML format.

11. The method of claim 8, wherein the wrapper provides interaction with one or more features exposed by the web service.

12. The method of claim 8, wherein the wrapper is wholly executable on a client browser.

13. The method of claim 8, further comprising:
calling code in the wrapper when a user adds the wrapper to a design surface in the visual mashup designer, the code telling the wrapper and the visual mashup designer how to interact.

14. A computer-readable medium having computer-executable instructions for causing a computer to perform the steps recited in claim 8.

15. A method for creating and using web service mashup wrapper components comprising the steps of:
receiving input from a user to initiate a creation of a wrapper for a web service, the wrapper being written in a dynamic language, the wrapper being operable to be used with a visual mashup designer for creation of web site mashups;
receiving input from the user to select the wrapper to include the wrapper as a component in a visual mashup designer; and
enabling the wrapper to respond to visual mashup designer events.

16. The method of claim 15, wherein the wrapper is operable to be displayed in a toolbox of components in the visual mashup designer.

17. The method of claim 15, wherein the dynamic language is JavaScript.

18. The method of claim 15, wherein communications between the wrapper and the web service are transmitted in an XML format.

19. The method of claim 15, wherein the wrapper is wholly executable on a client browser.

20. A computer-readable medium having computer-executable instructions for causing a computer to perform the steps recited in claim 15.
